(19) United States
(12) Patent Application Publication
(10) Pub. No.: US 2026/0189846 A1
(43) Pub. Date: Jul. 2, 2026

(54) COMPOSITE SPEAKER

(71) Applicant: AAC Microtech (Changzhou) Co., Ltd., Changzhou City (CN)

(72) Inventors: Weimin Chen, Changzhou (CN); Yao Hui, Changzhou (CN); Xingchi Chen, Changzhou (CN)

(21) Appl. No.: 19/319,784

(22) Filed: Sep. 5, 2025

Related U.S. Application Data
(63) Continuation of application No. PCT/CN2024/142831, filed on Dec. 26, 2024.

(51) Int. Cl. H04R 1/24; H04R 1/02; H04R 1/28; H04R 7/18; H04R 9/02; H04R 9/06

(52) U.S. Cl. CPC H04R 1/24; H04R 1/025; H04R 1/2873; H04R 7/18; H04R 9/025; H04R 9/06; H04R 2400/11

(57) ABSTRACT

The present application provides a composite speaker, comprising a frame, a vibration system fixed to the frame, and a magnetic circuit system for driving the vibration system to vibrate and sound; the vibration system comprises a first bass unit and a high pitched unit located on the first side of the magnetic circuit system, as well as a second bass unit located on the second side of the magnetic circuit system; the first bass unit and the high pitched unit are coaxially arranged, and the first bass unit is arranged around the outside of the high pitched unit; the magnetic circuit system comprises a central magnet and an edge magnet located on the outer periphery of the central magnet; the central magnet and the edge magnet are magnetized in reverse.

### CROSS REFERENCE TO RELATED APPLICATIONS

The present application claims priority to PCT Patent Application No. PCT/CN 2024/142831, entitled “A COMPOSITE SPEAKER” filed Dec. 26, 2024, the entire contents of which are incorporated herein by reference.

### TECHNICAL FIELD

The present application relates to the technical field of electroacoustic, in particular to a composite speaker.

### BACKGROUND

The market for AR or VR glasses is growing at present. However, the AR/VR glasses equipped with the speaker is usually single-sided and single-speaker, either in the form of a speaker box or a single speaker with single driver. There are usually the following shortcomings: 1, although the speaker monomer is a natural dipole with good isolation in low frequency, but the isolation in the mid-to-high frequency part has peaks and valleys, which does not meet expectations; 2, the current speakers often have a large valley value in the high frequency part, which affects the listening experience.

Therefore, it is necessary to provide a composite speaker with better isolation and excellent frequency response in both the high and low frequencies.

### SUMMARY

The purpose of the present application is to provide a composite speaker, which has better isolation performance and excellent frequency response for both high and low frequencies.

The technical solution of the present application is as follows:

The present application provides a composite speaker, comprising a frame, a vibration system fixed to the frame, and a magnetic circuit system driving the vibration system to vibrate and sound; the vibration system comprises a first bass unit and a high pitched unit located on the first side of the magnetic circuit system, as well as a second bass unit located on the second side of the magnetic circuit system; the first bass unit and the high pitched unit are coaxially arranged, and the first bass unit is arranged around the outside of the high pitched unit; the magnetic circuit system comprises a central magnet and an edge magnet located on the outer periphery of the central magnet; the central magnet and the edge magnet are magnetized in reverse.

As an improvement, the frame comprises a first frame and a second frame arranged on the first side of the magnetic circuit system, and a third frame arranged on the second side of the magnetic circuit system; the first frame and the second frame are coaxially arranged, and the first frame is arranged around the outer circumference of the second frame; the first bass unit is supported on the side of the first frame away from the magnetic circuit system, the high pitched unit is supported on the side of the second frame away from the magnetic circuit system, and the second bass unit is supported on the side of the third frame away from the magnetic circuit system.

As an improvement, the first bass unit comprises a first bass voice coil and a first bass diaphragm, wherein the first bass diaphragm is located on the side of the first bass voice coil away from the magnetic circuit system and supported by the first frame; the high pitched unit comprises a high pitched voice coil and a high pitched diaphragm, wherein the high pitched diaphragm is located on the side of the high pitched voice coil away from the magnetic circuit system and supported by the second frame; the second bass unit comprises a second bass voice coil and a second bass diaphragm arranged on the second side of the magnetic circuit system, wherein the second bass diaphragm is arranged on the side of the second bass voice coil away from the magnetic circuit system and supported by the third frame.

As an improvement, the edge magnet comprises a first edge magnet arranged on the outer periphery of the central magnet and a second edge magnet arranged on the first side of the central magnet, wherein the first edge magnet and the central magnet are spaced apart, and both the first edge magnet and the second edge magnet are magnetized in reverse to the central magnet; the magnetic circuit system further comprises a first magnetic bowl, a second magnetic bowl, a third magnetic bowl, and a fourth magnetic bowl, wherein the first magnetic bowl is used to accommodate the central magnet, the second magnetic bowl is located on the second side of the first edge magnet and is aligned with the first edge magnet, the third magnetic bowl is covered on the first side of the central magnet, the second edge magnet is located on the first side of the third magnetic bowl, and the fourth magnetic bowl is covered on the second edge magnet.

As an improvement, the first magnetic bowl comprises a first tablet, a first side panel located at the edge of the first tablet, and a second tablet located at one end of the first side panel away from the first tablet, wherein the central magnet is located on the first tablet and is spaced apart from the first side panel to form a first magnetic gap; the second tablet extends to the first side of the first edge magnet, and the first edge magnet is sandwiched between the second tablet and the second magnetic bowl; the second magnetic bowl and the first edge magnet are both spaced apart from the first side panel to form a second magnetic gap; the third magnetic bowl comprises a ring-shaped third tablet and a second side panel located on the inner edge of the third tablet, wherein the second side panel extends in a direction away from the first side of the third tablet until it is flush with the fourth magnetic bowl, the fourth magnetic bowl is aligned with the inner wall of the second edge magnet, and the second edge magnet and the second side panel are spaced apart to form a third magnetic gap.

As an improvement, the first frame is supported on the first side of the first edge magnet, and the first bass voice coil is inserted into the first magnetic gap; the second frame is supported on the first side of the second edge magnet, and the high pitched voice coil is inserted into the third magnetic gap; the third frame is supported on the second side of the second magnetic bowl, and the second bass voice coil is inserted into the second magnetic gap.

As an improvement, the edge magnet comprises a third edge magnet arranged on the outer periphery of the central magnet, the central magnet and the third edge magnet are magnetized in reverse, and the third edge magnet is spaced apart from the central magnet; the magnetic circuit system further comprises a fifth magnetic bowl, a sixth magnetic bowl, and a seventh magnetic bowl, wherein the fifth magnetic bowl is used to accommodate the central magnet, the sixth magnetic bowl is located on the second side of the third edge magnet and is aligned with the third edge magnet, the seventh magnetic bowl is covered on the first side of the central magnet and is aligned with the central magnet; the fifth magnetic bowl comprises a fourth tablet, a fourth side panel located at the edge of the fourth tablet, a fifth tablet located at one end of the fourth side panel away from the fourth tablet, and a fifth side panel located in the central area of the fourth tablet, wherein the fifth side panel extends from the first side of the fourth tablet to be flush with the seventh magnetic bowl; the central magnet is located on the fourth tablet, and is spaced apart from the fourth side panel to form a fourth magnetic gap, the central magnet is spaced apart from the fifth side panel to form a fifth magnetic gap.

As an improvement, the fifth tablet extends to the first side of the third edge magnet, and the third edge magnet is sandwiched between the fifth tablet and the sixth magnetic bowl; the third edge magnet and the sixth magnetic bowl are both spaced apart from the fourth side panel to form a sixth magnetic gap; the first frame is supported on the first side of the third edge magnet, and the first bass voice coil is inserted into the fourth magnetic gap; the second frame is supported on the first side of the seventh magnetic bowl, and the high pitched voice coil is inserted into the fifth magnetic gap; the third frame is supported on the second side of the sixth magnetic bowl, and the second bass voice coil is inserted into the sixth magnetic gap.

As an improvement, the composite speaker further comprises a shell, which includes a first shell and a second shell that are interconnected, the magnetic circuit system, the vibration system, and the frame are housed in the first shell, and the first frame, the magnetic circuit system, and the second frame separate the shell into multiple sound chambers.

As an improvement, the aperture of the first shell is larger than that of the second shell, and the magnetic circuit system, the vibration system, and the frame are assembled to form a sound monomer, a first partition board is provided in the cavity of the first shell away from the second shell, which corresponds to the opening of the second shell, the sound monomer is located in the area surrounded by the inner wall of the first shell and the first partition board; the first shell and the first side of the sound monomer are enclosed to form a first sound emitting front chamber, and the first shell and the second side of the sound monomer are enclosed to form a second sound emitting front chamber; the end plates of one end of the first shell extend to the first frame and the second frame, respectively, the connection between the second shell and the sound monomer forms a sound producing rear chamber, and the sound monomer and the first shell enclose a closed high pitched rear chamber; one end of the first shell is provided with a first sound outlet, and the first sound emitting front chamber and the second sound emitting front chamber converge and connect to the first sound outlet; the second shell is equipped with a second sound outlet that is connected to the sound producing rear chamber.

As an improvement, the shell further comprises a second partition board and a third partition board arranged inside the first shell and connected to the first partition board on the first and second sides, wherein the first shell, the first side of the sound monomer, and the second partition board enclose a first sound emitting front chamber; the second shell, the second side of the sound monomer, and the third partition board enclose a second sound emitting front chamber, the first shell has two first sound outlets at one end away from the second shell, and the first sound emitting front chamber and the second sound emitting front chamber are respectively connected to one of the first sound outlets.

As an improvement, the area where the magnetic circuit system is connected to the first shell is provided with a leakage hole.

The beneficial effects of the present application are that the composite speaker of the present application can produce sound on both sides, improve the effective sound radiation area, enhance frequency response, reduce structural nonlinearity, reduce distortion, and improve the sound quality of the speaker; the vibration system includes both a bass sound unit and a high pitched unit, which compensates for the insufficient high-frequency response of the speaker.

### BRIEF DESCRIPTION OF THE DRAWINGS

FIG. 1 is a structural view of the first structure of a composite speaker of the present application.

FIG. 2 is an exploded view of the first structure of the composite speaker of the present application.

FIG. 3 is an vertical view of the first structure of the composite speaker of the present application.

FIG. 4 is a sectional view of FIG. 3 taken along line A-A.

FIG. 5 is a structural view of the magnetization direction of the magnetic circuit system in the first structure of the composite speaker of the present application.

FIG. 6 is an exploded view of the second structure of the composite speaker of the present application.

FIG. 7 is an vertical view of the second structure of the composite speaker of the present application.

FIG. 8 is a sectional view of FIG. 7 taken along line B-B.

FIG. 9 is a structural view of the magnetization direction of the magnetic circuit system in the second structure of the composite speaker of the present application.

FIG. 10 is a structural view of the first structure of the shell of the composite speaker of the present application.

FIG. 11 is a distribution view of the sound chambers inside the composite speaker shown in FIG. 10.

FIG. 12 is a structural view of the second structure of the shell of the composite speaker of the present application.

FIG. 13 is a distribution view of the sound chambers inside the composite speaker shown in FIG. 12.

FIG. 14 is a location view of the leakage holes in the composite speaker of the present application.

### DETAILED DESCRIPTION OF THE EMBODIMENTS

The present application will be further explained in conjunction with the accompanying drawings and embodiments.

### Implementation Example

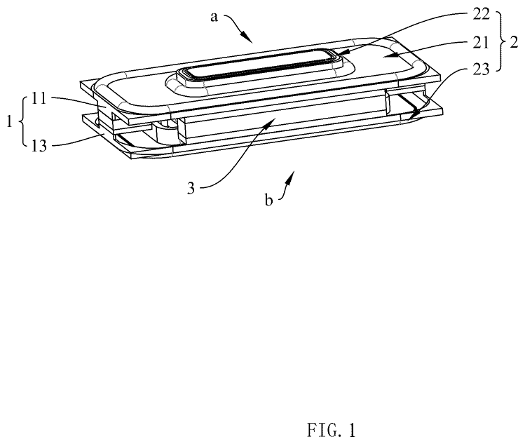

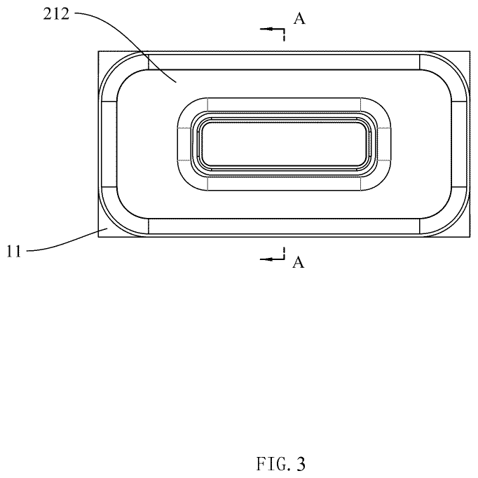

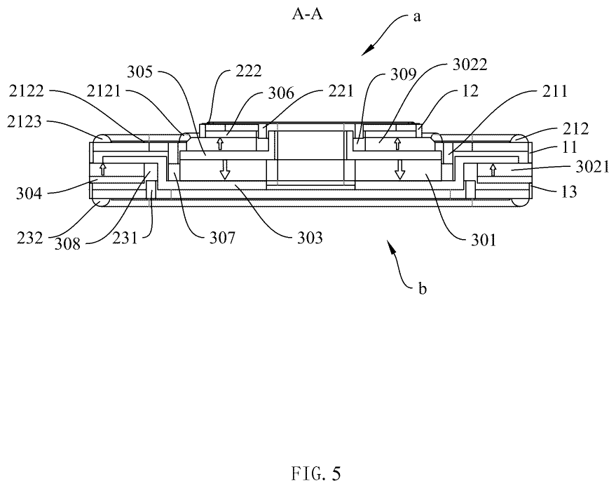

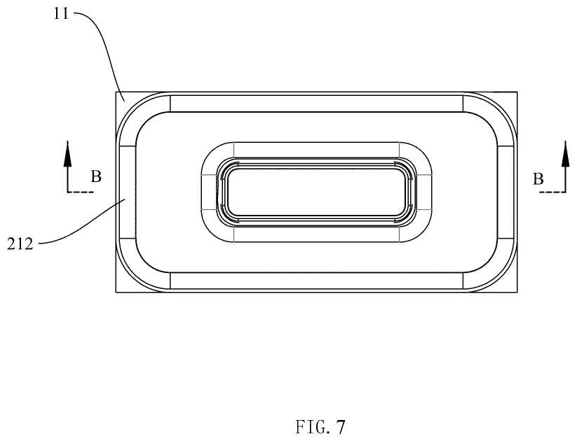

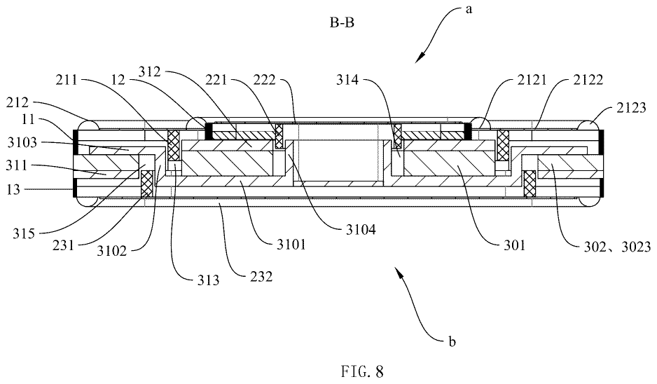

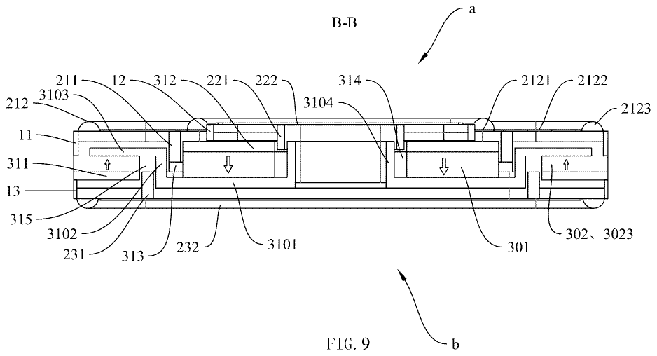

The present application provides a composite speaker, as shown in FIGS. 1-9, comprising a frame 1, a vibration system 2 fixed to the frame 1, and a magnetic circuit system 3 driving the vibration system 2 to vibrate and sound. The vibration system 2 comprises a first bass unit 21 and a high pitched unit 22 located on the first side a of the magnetic circuit system 3, as well as a second bass unit 23 located on the second side b of the magnetic circuit system 3. The first bass unit 21 and the high pitched unit 22 are coaxially arranged, and the first bass unit 21 is arranged around the outside of the high pitched unit 22. The magnetic circuit system 3 comprises a central magnet 301 and an edge magnet 302 located on the outer periphery of the central magnet 301. The central magnet 301 and the edge magnet 302 are magnetized in reverse.

The composite speaker of the present application is equipped with sound units on both sides of the magnetic circuit system 3, which can produce sound on both sides, improve the effective sound radiation area, enhance frequency response, reduce structural nonlinearity, reduce distortion, and improve the sound quality of the speaker. The vibration system 2 includes both bass sound units and a high pitched unit 22, and the setting of the high pitched unit 22 can compensate for the insufficient high-frequency response of the bass sound units. The high pitched unit 22 and the first bass unit 21 of the first side a are driven in one way, and the second bass unit 23 of the second side b is driven in the other way. In the low frequency range, both sides of the first side a and the second side b are driven to produce sound simultaneously, that is, to vibrate in the opposite direction. In the mid to high frequency range, the sound isolation can be further enhanced through algorithms according to actual needs, thereby improving the isolation of the speaker. The central magnet 301 and the edge magnet 302 in the magnetic circuit system 3 are magnetized in reverse, causing the first side a and the second side b of the magnetic circuit system 3 to produce sound in the same direction, that is, to vibrate in the opposite direction, which can reduce shell vibration. The first bass unit 21, the high pitched unit 22, and the second bass unit 23 in the vibration system 2 share a set of magnetic circuit system 3, which simplifies the overall structure of the speaker, reduces the volume of the speaker, reduces the occupied space, and facilitates the miniaturization design of the speaker. The composite speaker described in the present application is suitable for electronic devices with high privacy for speech, such as mobile phones, AR or VR glasses, or tablets.

The frame 1 comprises a first frame 11 and a second frame 12 arranged on the first side a of the magnetic circuit system 3, and a third frame 13 arranged on the second side b of the magnetic circuit system 3. The first frame 11 and the second frame 12 are coaxially arranged, and the first frame 11 is arranged around the outer circumference of the second frame 12. The first bass unit 21 is supported on the side of the first frame 11 away from the magnetic circuit system 3. The high pitched unit 22 is supported on the side of the second frame 12 away from the magnetic circuit system 3, and the second bass unit 23 is supported on the side of the third frame 13 away from the magnetic circuit system 3.

The first bass unit 21 comprises a first bass voice coil 211 and a first bass diaphragm 212. The first bass diaphragm 212 is located on the side of the first bass voice coil 211 away from the magnetic circuit system 3 and supported by the first frame 11. The high pitched unit 22 comprises a high pitched voice coil 221 and a high pitched diaphragm 222. The high pitched diaphragm 222 is located on the side of the high pitched voice coil 221 away from the magnetic circuit system 3 and supported by the second frame 12. The second bass unit 23 comprises a second bass voice coil 231 and a second bass diaphragm 232 arranged on the second side b of the magnetic circuit system 3. The second bass diaphragm 232 is arranged on the side of the second bass voice coil 231 away from the magnetic circuit system 3 and supported by the third frame 13.

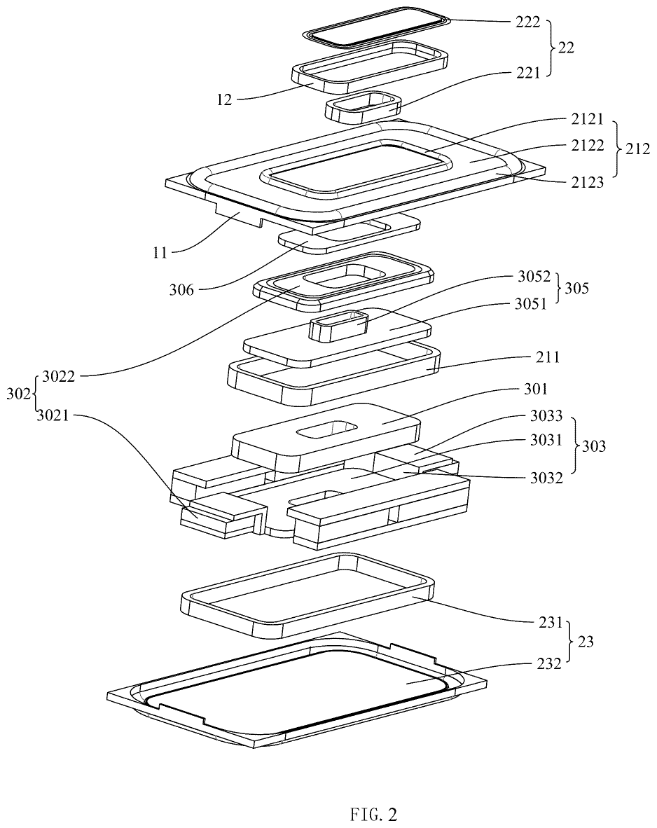

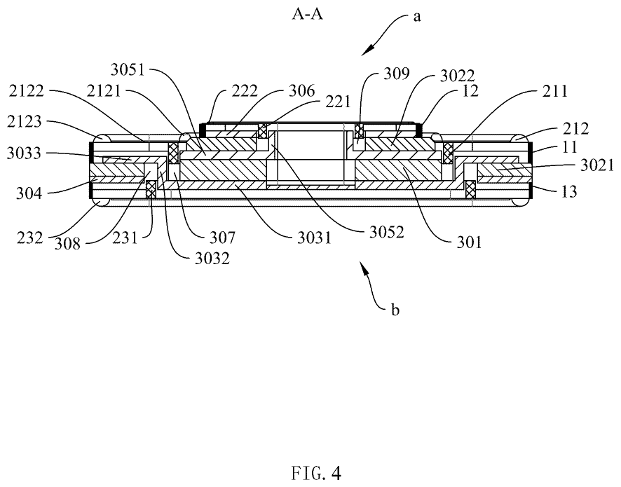

As shown in FIGS. 2-9, the first bass diaphragm 212 is annular in shape. The first bass diaphragm 212 includes a first folding ring 2121, a central portion 2122, and a second folding ring 2123 connected in sequence from the inside out. The inner edge of the first folding ring 2121 is connected to the second frame 12, and the outer edge is connected to the first bass voice coil 211. The outer edge of the second folding ring 2123 is connected to the first frame 11. As shown in FIG. 4, in some embodiments, the first folding ring 2121 and the second folding ring 2123 may have upward protruding structures. In other embodiments, the first folding ring 2121 and the second folding ring 2123 may also have a downward concave structures. The inner direction refers to the direction close to the central axis of the composite speaker, while the outer direction refers to the direction away from the central axis of the composite speaker.

Referring to FIGS. 2-5, the first structure of the composite speaker provided by the present application is shown. The edge magnet 302 comprises a first edge magnet 3021 arranged on the outer periphery of the central magnet 301 and a second edge magnet 3022 arranged on the first side a of the central magnet 301. The first edge magnet 3021 and the central magnet 301 are spaced apart, and both the first edge magnet 3021 and the second edge magnet 3022 are magnetized in reverse to the central magnet 301. The magnetic circuit system 3 further comprises a first magnetic bowl 303, a second magnetic bowl 304, a third magnetic bowl 305, and a fourth magnetic bowl 306. The first magnetic bowl 303 is used to accommodate the central magnet 301. The second magnetic bowl 304 is located on the second side b of the first edge magnet 3021 and is aligned with the first edge magnet 3021. The third magnetic bowl 305 is covered on the first side a of the central magnet 301. The second edge magnet 3022 is located on the first side a of the third magnetic bowl 305, and the fourth magnetic bowl 306 is covered on the second edge magnet 3022. The first frame 11 is supported on the first side a of the first edge magnet 3021. The second frame 12 is supported on the first side a of the second edge magnet 3022, and the third frame 13 is supported on the second side b of the second magnetic bowl 304.

The central magnet 301 has a circular structure, and the second edge magnet 3022 also has a circular structure. The first magnetic bowl 303, the second magnetic bowl 304, the third magnetic bowl 305, and the fourth magnetic bowl 306 are all made of soft magnetic material made of low-carbon steel.

In one embodiment of the present application, the first magnetic bowl 303 comprises a first tablet 3031, a first side panel 3032 located at the edge of the first tablet 3031, and a second tablet 3033 located at one end of the first side panel 3032 away from the first tablet 3031. The central magnet 301 is located on the first tablet 3031 and is spaced apart from the first side panel 3032 to form a first magnetic gap 307. The second tablet 3033 extends to the first side a of the first edge magnet 3021, and the first edge magnet 3021 is sandwiched between the second tablet 3033 and the second magnetic bowl 304. The second magnetic bowl 304 and the first edge magnet 3021 are both spaced apart from the first side panel 3032 to form a second magnetic gap 308. The third magnetic bowl 305 comprises a ring-shaped third tablet 3051 and a second side panel 3052 located on the inner edge of the third tablet 3051. The second side panel 3052 extends in a direction away from the first side a of the third tablet 3051 until it is flush with the fourth magnetic bowl 306. The fourth magnetic bowl 306 is aligned with the inner wall of the second edge magnet 3022, and the second edge magnet 3022 and the second side panel 3052 are spaced apart to form a third magnetic gap 309. The first frame 11 is supported on the first side a of the first edge magnet 3021, and the first bass voice coil 211 is inserted into the first magnetic gap 307. The second frame 12 is supported on the first side a of the second edge magnet 3022, and the high pitched voice coil 221 is inserted into the third magnetic gap 309. The third frame 13 is supported on the second side b of the second magnetic bowl 304, and the second bass voice coil 231 is inserted into the second magnetic gap 308.

The outer wall of the first edge magnet 3021 is aligned with the outer wall of the second magnetic bowl 304, and the outer wall of the first frame 11 is aligned with the outer wall of the first edge magnet 3021. The outer wall of the third frame 13 is aligned with the outer wall of the second magnet 304.

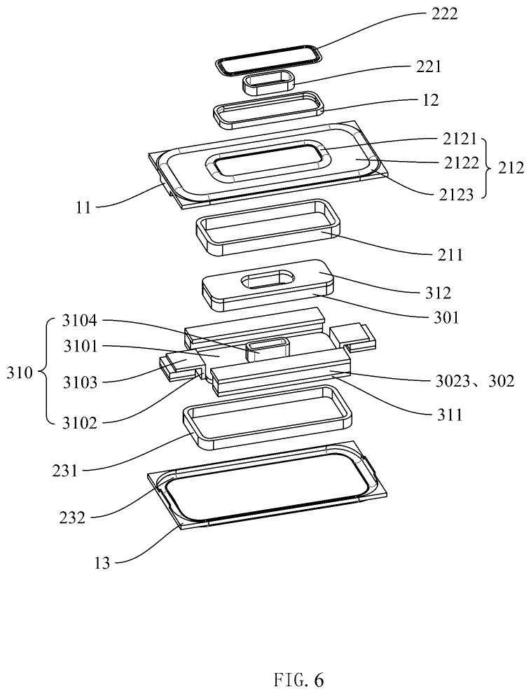

Referring to FIGS. 6-9, the second structure of the composite speaker provided by the present application is shown. In another specific embodiment of the present application, the structure of the magnetic circuit system 3 is adjusted. Specifically, the edge magnet comprises a third edge magnet 3023 arranged on the outer periphery of the central magnet 301. The central magnet 301 and the third edge magnet 3023 are magnetized in reverse, and the third edge magnet 3023 is spaced apart from the central magnet 301. The magnetic circuit system 3 further comprises a fifth magnetic bowl 310, a sixth magnetic bowl 311, and a seventh magnetic bowl 312. The fifth magnetic bowl 310 is used to accommodate the central magnet 301. The sixth magnetic bowl 311 is located on the second side b of the third edge magnet 3023 and is aligned with the third edge magnet 3023. The seventh magnetic bowl 312 is covered on the first side a of the central magnet 301 and is aligned with the central magnet 301.

The fifth magnetic bowl 310 comprises a fourth tablet 3101, a fourth side panel 3102 located at the edge of the fourth tablet 3101, a fifth tablet 3103 located at one end of the fourth side panel 3102 away from the fourth tablet 3101, and a fifth side panel 3104 located in the central area of the fourth tablet 3101. The fifth side panel 3104 extends from the first side a of the fourth tablet 3101 to be flush with the seventh magnetic bowl 312. The central magnet 301 is located on the fourth tablet 3101, and is spaced apart from the fourth side panel 3102 to form a fourth magnetic gap 313. The fifth tablet 3103 extends to the first side a of the third edge magnet 3023, and the third edge magnet 3023 is sandwiched between the fifth tablet 3103 and the sixth magnetic bowl 311. The third edge magnet 3023 and the sixth magnetic bowl 311 are both spaced apart from the fourth side panel 3102 to form a sixth magnetic gap 315. The central magnet 301 is spaced apart from the fifth side panel 3104 to form a fifth magnetic gap 314. The first frame 11 is supported on the first side a of the third edge magnet 3023, and the first bass voice coil 211 is inserted into the fourth magnetic gap 313. The second frame 12 is supported on the first side a of the seventh magnetic bowl 312, and the high pitched voice coil 221 is inserted into the fifth magnetic gap 314. The third frame 13 is supported on the second side b of the sixth magnetic bowl 311, and the second bass voice coil 231 is inserted into the sixth magnetic gap 315.

The outer wall of the third edge magnet 3023 is aligned with the outer wall of the sixth magnetic bowl 311, and the outer wall of the first frame 11 is aligned with the outer wall of the third edge magnet 3023. The outer wall of the third frame 13 is aligned with the outer wall of the sixth magnetic bowl 311.

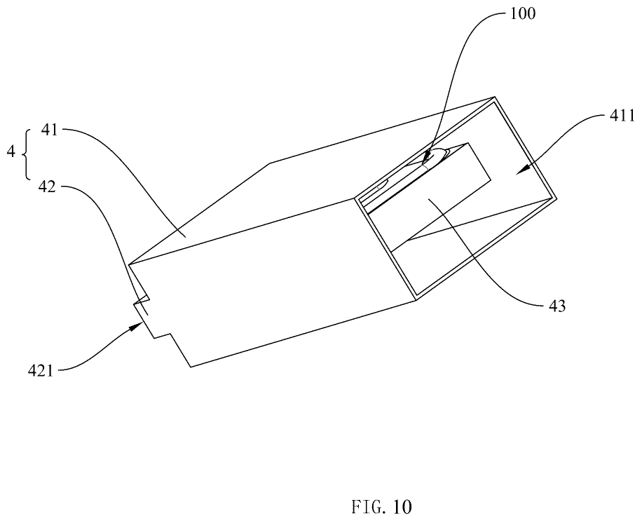

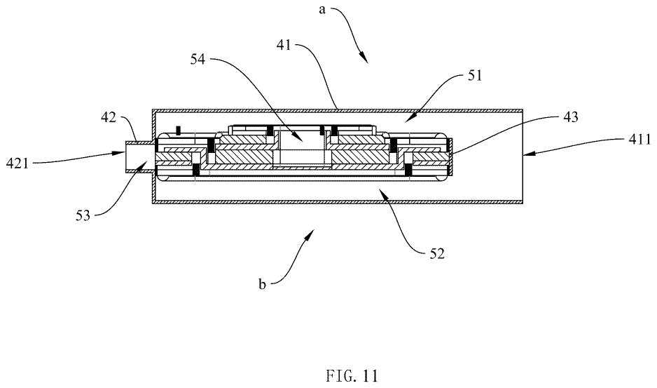

Furthermore, referring to FIGS. 10-13, the composite speaker of the present application further comprises a shell 4, which includes a first shell 41 and a second shell 42 that are interconnected. The magnetic circuit system 3, vibration system 2, and frame 1 are housed in the first shell 41, and the first frame 11, magnetic circuit system 3, and second frame 12 separate the shell 4 into multiple sound chambers. The aperture of the first shell 41 is larger than that of the second shell 42, and the magnetic circuit system 3, vibration system 2, and frame 1 are assembled to form a sound monomer 100. A first partition board 43 is provided in the cavity of the first shell 41 away from the second shell 42, which corresponds to the second shell 42. The sound monomer 100 is located in the area surrounded by the inner wall of the first shell 41 and the first partition board 43. The first shell 41 and the first side a of the sound monomer 100 are enclosed to form a first sound emitting front chamber 51, and the first shell 41 and the second side b of the sound monomer 100 are enclosed to form a second sound emitting front chamber 52. The end plates of one end of the first shell 41 extend to the first frame 11 and the second frame 12, respectively. The connection between the second shell 42 and the sound monomer 100 forms a sound producing rear chamber 53, and the sound monomer 100 and the first shell 41 enclose a closed high pitched rear chamber 54. One end of the first shell 41 is provided with a first sound outlet 411, and the first sound emitting front chamber 51 and the second sound emitting front chamber 52 converge and connect to the first sound outlet 411. The second shell 42 is equipped with a second sound outlet 421 that is connected to the sound producing rear chamber 53. In the embodiment of the present application, the first sound emitting front chamber 51 and the second sound emitting front chamber 52 converge at the same first sound outlet 411, producing double-sided sound and increasing the effective radiation area to enhance frequency response. In addition, it can also reduce the temperature of the voice coil and improve the reliability of the product. The specific structure of the shell 4 can be selected according to actual needs. For example, referring to FIG. 10 and FIG. 11, the first shell 41 and the second shell 42 are both square cylindrical in shape. The aperture of the first shell 41 is larger than that of the second shell 42. The sound monomer 100 includes a long side and a short side. The long side wall of the sound monomer 100 is connected to the inner wall of the side plate of the first shell 41, and the short side wall of one side of the sound monomer 100 is connected to the inner wall of one end of the first shell 41 near the second shell 42. The first partition board 43 is connected to the short side of the other side of the sound monomer 100.

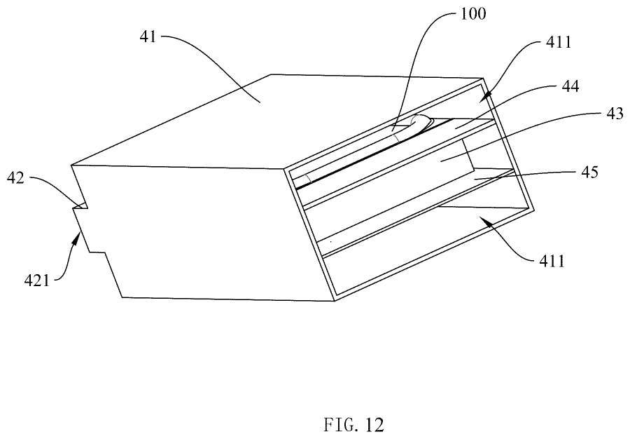

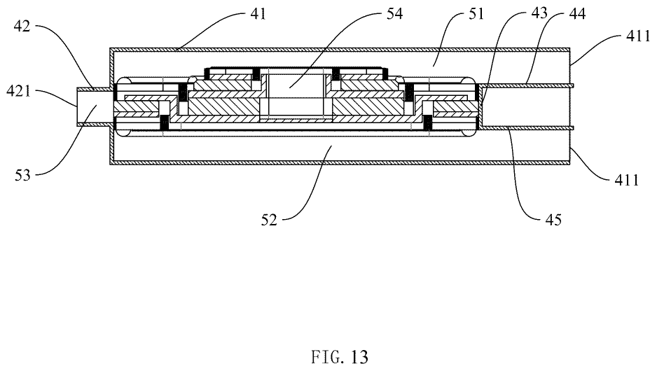

In another specific embodiment, referring to FIG. 12 and FIG. 13, compared to the aforementioned shell 4, the shell 4 further comprises a second partition board 44 and a third partition board 45 arranged inside the first shell 41 and connected to the first partition board 43 on the first side a and the second side b. The first shell 41, the first side a of the sound monomer 100, and the second partition board 44 enclose a first sound emitting front chamber 51, and the second shell 42, the second side b of the sound monomer 100, and the third partition board 45 enclose a second sound emitting front chamber 52.The first shell 41 has two first sound outlets 411 at one end away from the second shell 42, and the first sound emitting front chamber 51 and the second sound emitting front chamber 52 are respectively connected to one of the first sound outlets 411. In the embodiment of the present application, the first sound emitting front chamber 51 and the second sound emitting front chamber 52 are separated to produce sound. In this structure, the effect of privacy communication can be improved by setting the position of the sound outlets.

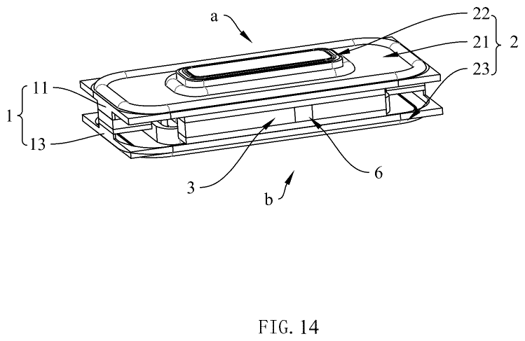

Furthermore, referring to FIG. 14, the area where the magnetic circuit system 3 is connected to the first shell 41 is provided with a leakage hole 6. The setting of the leakage hole 6 can ensure air leakage, air circulation and sound transmission, and further ensure the quality of the speaker. As an option, the number and location of the leakage holes 6 can be specifically set according to actual needs.

As an option, in some embodiments, the central magnet 301 is overall rectangular in shape. When the composite speaker adopts the first structure, the first edge magnet 3021 includes a first long edge magnet corresponding to the long side of the central magnet 301, and a first short edge magnet corresponding to the short side of the central magnet 301. The leakage hole 6 can be opened on the first long edge magnet, and the position of the leakage hole 6 is not limited. The leakage hole 6 can also be located on the first magnetic bowl 303 and/or the second magnetic bowl 304 connected to the first long edge magnet. When the composite speaker adopts the second structure, the third edge magnet 3023 includes a second long edge magnet corresponding to the long side of the central magnet 301 and a second short edge magnet corresponding to the short side of the central magnet 301. The leakage hole 6 can be opened on the second long edge magnet, and the leakage hole 6 can also be opened on the fifth magnetic bowl 310 and/or the sixth magnetic bowl 311 connected to the second long edge magnet.

It should be noted that the speaker structure obtained by freely combining the vibration system 2, magnetic circuit system 3, and shell 4 disclosed in the above embodiments of the present application falls within the protection scope of the present application.

Described above are only embodiments of the present application. It should be pointed out that for ordinary technical personnel in this field, improvements can be made without departing from the inventive concept of the present application, but these are all within the protection scope of the present application.

What is claimed is:

1. A composite speaker, comprising:
a frame, a vibration system fixed to the frame, and a magnetic circuit system driving the vibration system to vibrate and sound; the vibration system comprises a first bass unit and a high pitched unit located on the first side of the magnetic circuit system, as well as a second bass unit located on the second side of the magnetic circuit system; the first bass unit and the high pitched unit are coaxially arranged, and the first bass unit is arranged around the outside of the high pitched unit; the magnetic circuit system comprises a central magnet and an edge magnet located on the outer periphery of the central magnet; the central magnet and the edge magnet are magnetized in reverse.

2. The composite speaker of claim 1, wherein the frame comprises a first frame and a second frame arranged on the first side of the magnetic circuit system, and a third frame arranged on the second side of the magnetic circuit system; the first frame and the second frame are coaxially arranged, and the first frame is arranged around the outer circumference of the second frame; the first bass unit is supported on the side of the first frame away from the magnetic circuit system, the high pitched unit is supported on the side of the second frame away from the magnetic circuit system, and the second bass unit is supported on the side of the third frame away from the magnetic circuit system.

3. The composite speaker of claim 2, wherein the first bass unit comprises a first bass voice coil and a first bass diaphragm, wherein the first bass diaphragm is located on the side of the first bass voice coil away from the magnetic circuit system and supported by the first frame; the high pitched unit comprises a high pitched voice coil and a high pitched diaphragm, wherein the high pitched diaphragm is located on the side of the high pitched voice coil away from the magnetic circuit system and supported by the second frame; the second bass unit comprises a second bass voice coil and a second bass diaphragm arranged on the second side of the magnetic circuit system, wherein the second bass diaphragm is arranged on the side of the second bass voice coil away from the magnetic circuit system and supported by the third frame.

4. The composite speaker of claim 3, wherein the edge magnet comprises a first edge magnet arranged on the outer periphery of the central magnet and a second edge magnet arranged on the first side of the central magnet, wherein the first edge magnet and the central magnet are spaced apart, and both the first edge magnet and the second edge magnet are magnetized in reverse to the central magnet; the magnetic circuit system further comprises a first magnetic bowl, a second magnetic bowl, a third magnetic bowl, and a fourth magnetic bowl, wherein the first magnetic bowl is used to accommodate the central magnet, the second magnetic bowl is located on the second side of the first edge magnet and is aligned with the first edge magnet, the third magnetic bowl is covered on the first side of the central magnet, the second edge magnet is located on the first side of the third magnetic bowl, and the fourth magnetic bowl is covered on the second edge magnet.

5. The composite speaker of claim 4, wherein the first magnetic bowl comprises a first tablet, a first side panel located at the edge of the first tablet, and a second tablet located at one end of the first side panel away from the first tablet, wherein the central magnet is located on the first tablet and is spaced apart from the first side panel to form a first magnetic gap; the second tablet extends to the first side of the first edge magnet, and the first edge magnet is sandwiched between the second tablet and the second magnetic bowl; the second magnetic bowl and the first edge magnet are both spaced apart from the first side panel to form a second magnetic gap; the third magnetic bowl comprises a ring-shaped third tablet and a second side panel located on the inner edge of the third tablet, wherein the second side panel extends in a direction away from the first side of the third tablet until it is flush with the fourth magnetic bowl, the fourth magnetic bowl is aligned with the inner wall of the second edge magnet, and the second edge magnet and the second side panel are spaced apart to form a third magnetic gap.

6. The composite speaker composite speaker of claim 5, wherein the first frame is supported on the first side of the first edge magnet, and the first bass voice coil is inserted into the first magnetic gap; the second frame is supported on the first side of the second edge magnet, and the high pitched voice coil is inserted into the third magnetic gap; the third frame is supported on the second side of the second magnetic bowl, and the second bass voice coil is inserted into the second magnetic gap.

7. The composite speaker of claim 3, wherein the edge magnet comprises a third edge magnet arranged on the outer periphery of the central magnet, the central magnet and the third edge magnet are magnetized in reverse, and the third edge magnet is spaced apart from the central magnet; the magnetic circuit system further comprises a fifth magnetic bowl, a sixth magnetic bowl, and a seventh magnetic bowl, wherein the fifth magnetic bowl is used to accommodate the central magnet, the sixth magnetic bowl is located on the second side of the third edge magnet and is aligned with the third edge magnet, the seventh magnetic bowl is covered on the first side of the central magnet and is aligned with the central magnet; the fifth magnetic bowl comprises a fourth tablet, a fourth side panel located at the edge of the fourth tablet, a fifth tablet located at one end of the fourth side panel away from the fourth tablet, and a fifth side panel located in the central area of the fourth tablet, wherein the fifth side panel extends from the first side of the fourth tablet to be flush with the seventh magnetic bowl; the central magnet is located on the fourth tablet, and is spaced apart from the fourth side panel to form a fourth magnetic gap, the central magnet is spaced apart from the fifth side panel to form a fifth magnetic gap.

8. The composite speaker of claim 7, wherein the fifth tablet extends to the first side of the third edge magnet, and the third edge magnet is sandwiched between the fifth tablet and the sixth magnetic bowl; the third edge magnet and the sixth magnetic bowl are both spaced apart from the fourth side panel to form a sixth magnetic gap; the first frame is supported on the first side of the third edge magnet, and the first bass voice coil is inserted into the fourth magnetic gap; the second frame is supported on the first side of the seventh magnetic bowl, and the high pitched voice coil is inserted into the fifth magnetic gap; the third frame is supported on the second side of the sixth magnetic bowl, and the second bass voice coil is inserted into the sixth magnetic gap.

9. The composite speaker of claim 2, wherein the composite speaker further comprises a shell, which includes a first shell and a second shell that are interconnected, the magnetic circuit system, the vibration system, and the frame are housed in the first shell, and the first frame, the magnetic circuit system, and the second frame separate the shell into multiple sound chambers.

10. The composite speaker of claim 9, wherein the aperture of the first shell is larger than that of the second shell, and the magnetic circuit system, the vibration system, and the frame are assembled to form a sound monomer, a first partition board is provided in the cavity of the first shell away from the second shell, which corresponds to the opening of the second shell, the sound monomer is located in the area surrounded by the inner wall of the first shell and the first partition board; the first shell and the first side of the sound monomer are enclosed to form a first sound emitting front chamber, and the first shell and the second side of the sound monomer are enclosed to form a second sound emitting front chamber; the end plates of one end of the first shell extend to the first frame and the second frame, respectively, the connection between the second shell and the sound monomer forms a sound producing rear chamber, and the sound monomer and the first shell enclose a closed high pitched rear chamber; one end of the first shell is provided with a first sound outlet, and the first sound emitting front chamber and the second sound emitting front chamber converge and connect to the first sound outlet; the second shell is equipped with a second sound outlet that is connected to the sound producing rear chamber.

11. The composite speaker of claim 10, wherein the shell further comprises a second partition board and a third partition board arranged inside the first shell and connected to the first partition board on the first and second sides, wherein the first shell, the first side of the sound monomer, and the second partition board enclose a first sound emitting front chamber; the second shell, the second side of the sound monomer, and the third partition board enclose a second sound emitting front chamber; the first shell has two first sound outlets at one end away from the second shell, and the first sound emitting front chamber and the second sound emitting front chamber are respectively connected to one of the first sound outlets.

12. The composite speaker of claim 9, wherein the area where the magnetic circuit system is connected to the first shell is provided with a leakage hole.
